(19) United States
(12) Patent Application Publication
(10) Pub. No.: US 2018/0312702 A1
(43) Pub. Date: Nov. 1, 2018

(54) CARRIER MEDIUM FOR SEPARATING PAINT OVERSPRAY

(71) Applicant: Henkel AG & Co. KGaA, Duesseldorf (DE)

(72) Inventor: Christian Kolt, Duesseldorf (DE)

(21) Appl. No.: 15/971,434

(22) Filed: May 4, 2018

Related U.S. Application Data
(63) Continuation of application No. PCT/EP2016/076476, filed on Nov. 3, 2016.

(30) Foreign Application Priority Data
Nov. 6, 2015 (EP) 15003191.2

(51) Int. Cl. C09D 7/00; B01D 45/10; B03C 3/16; B05B 14/42; B05B 14/465

(52) U.S. Cl. CPC C09D 7/71; B01D 45/10; B05B 14/465; B05B 14/42; B03C 3/16

(57) ABSTRACT

The invention relates to the use of a water-based carrier medium for wet scrubbing paint overspray from the circulating air in painting booths, the carrier medium containing at least 40 wt. % of polyfunctional organic oxo compounds. The carrier medium is characterized in that the viscosity thereof is within a specified range over a wide range of shear stresses, such that the carrier medium flows off of the separating surfaces of a wet scrubbing facility in a temporally homogeneous and approximately laminar manner. In a further aspect, the invention relates to a method for wet scrubbing using the aforementioned carrier medium.

The present invention relates to the use of a water-based carrier medium for wet scrubbing paint overspray from the circulating air in painting booths, the carrier medium containing at least 40 wt. % of polyfunctional organic oxo compounds. The carrier medium is characterized in that the viscosity thereof is within a specified range over a wide range of shear stresses, such that the carrier medium is guaranteed to flow off the separating surfaces of a wet scrubbing facility in a temporally homogeneous and approximately laminar manner. In a further aspect, the present invention relates to a method for wet scrubbing using the aforementioned carrier medium.

In paint shops, in particular in automotive manufacture, coats of paint based on one or more solvents or water are usually sprayed onto the components. Applying paints, waxes or other non-water soluble organic coating agents to metal surfaces or plastics surfaces in this manner does not make it possible for the paints or coating agents to be applied completely to the parts to be coated. The paint portion that is not deposited on the components as desired and that has to be removed from the circulating air is referred to as “paint overspray.” The paint overspray is introduced into a usually water-based liquid carrier medium so as to be separated from the circulating air (“wet scrubbing”), and is removed from the carrier medium and reused, after the particulate paint components have been debonded and coagulated. Depending on the facility configuration and procedure, after the paint overspray has been wet scrubbed in this manner, the debonded and coagulated paint particles are separated by flotation or sedimentation in a system tank which is created for this purpose and into which the carrier medium that now contains the paint overspray is transferred. The coagulate is removed from the carrier medium in the system tank continually and by using suitable removal devices and/or separators. In turn, the carrier medium that now does not contain the coagulate is continually fed back to the separation device of the painting booth for wet scrubbing, and therefore a circulation system is achieved.

The paint overspray is often wet scrubbed in the painting booth by turbulently mixing a liquid carrier medium and the aerosol of the “overspray” by means of a venturi nozzle in the circulating air duct of the painting booth. Alternatively, wet scrubbing methods are common in which the paint overspray is taken from the circulating air of the painting booth by means of a curtain formed of carrier medium that is flowing downward, at least in part, under the force of gravity, in which said overspray is removed together with the carrier medium, and in which said overspray is transferred as a load into a stilling tank containing the carrier medium.

WO 2008/067880 A2 fundamentally describes wet scrubbing of paint overspray on separating surfaces around which a liquid carrier medium flows, in which mixing of the carrier medium with the circulating air with vigorous turbulence is omitted in favor of a less energy-intensive procedure. As an adaptation to this specific method, said document proposes the use of a liquid carrier medium which has a low pressure, for example a plant oil or a mixture of glycol ethers, and in which the solid components of the paint overspray cannot dissolve or with which said components cannot form chemical bonds, however, such that it is possible to physically separate the paint overspray from the carrier medium in a simple manner. Furthermore, it is also described as being advantageous if the carrier medium itself is not prone to oxidative degradation, such that the average retention time of the carrier medium in the circulation system can be kept as long as possible.

In methods of the kind mentioned last, a variant has recently been established in which scrubbing takes place on separating surfaces over which the carrier medium flows, the paint overspray being ionized in the circulating air by a high voltage and being moved toward the separating surfaces in the electric field. For this purpose, the separating surfaces themselves are made of an electrically conductive material and are electrically connected to the opposite pole that brings about ionization. Promoting wet scrubbing of the paint overspray by applying a high voltage is described in WO 2010/025844 A1, and a suitable way of adapting the separating device to the specific method is presented which makes it possible to integrate the electrodes in each of the separating units comprising the separating surfaces around which a liquid carrier medium flows. In an efficient device, the electrode units are arranged at as short a distance as possible from the separating surface around which the carrier medium flows, in order to ensure that almost every ionized paint overspray particle is transferred along the electric field into the carrier medium while being transported together with the circulating air along the separating surfaces. This results in it being procedurally required that the carrier medium flows around the separating surfaces in as homogeneous a manner as possible and at a reproducible wet film thickness, in order for it to be possible to prevent electric arcs from occurring between the electrode unit and the separating surface.

In this connection, WO 2011/110302 A1 proposes using a mixture of one or more polyols and water, which contains a non-ionic surfactant, as a liquid carrier medium for wet scrubbing of paint overspray involving ionization, it being intended for the mixture to have a viscosity of 11-25 seconds at 23° C., measured according to DIN 53211 using a 4 mm flow cup. Preferred polyols are glycerol and polyalkylene glycols, it being possible to additionally add thickeners to the water-based carrier medium in order to set the desired viscosity.

When selecting the carrier medium in methods involving electrostatically assisted wet scrubbing of the paint overspray, it should also be taken into account that the flow properties can be kept stable while the carrier medium is flowing around the separating surfaces. In any case, the problems posed are evaporation losses and the chemical degradation of rheological additives by ozone, which is inevitably added to the circulating air when the paint overspray is ionized.

Furthermore, it is advantageous for the flow property profile of the carrier medium to be such that said medium has an increased viscosity at locations in the circulation system of the wet scrubber that have a very low shear rate, in order to thereby counteract rapid sedimentation of the paint overspray, for example in facility regions that have a low degree of carrier medium exchange or generally when the facility is out of operation.

The object of the present invention is to provide a liquid carrier medium for wet scrubbing paint overspray on separating surfaces around which the carrier medium flows, which provides for a high volume flow rate with flow behavior that is substantially influenced by the force of gravity, and in particular which ensures that the flowing carrier medium has a reproducible homogeneous wet film thickness on the separating surface in order to prevent electric arcs from occurring when ionized paint overspray particles are being separated electrostatically. In addition, for electrostatically assisted wet scrubbing of the paint overspray, it is required that the flow property profile can be kept stable, largely irrespective of the specific external influences, such that the average retention time of the carrier medium is as long as possible in order for the wet scrubber to be operated in an economical manner. Furthermore, it is desirable for it to be possible to counteract sedimentation in regions of the system circuit for the carrier medium that have a low degree of volume exchange or when the facility is out of operation, by skillfully selecting the carrier medium.

In a first aspect of the present invention, this object is achieved by the use of a water-based agent containing, in total, more than 40 wt. % of polyfunctional organic oxo compounds as a carrier medium for wet scrubbing paint overspray from painting booths, characterized in that, at shear rates in the range of from 10 to 1,000 s⁻¹, the water-based agent has a viscosity that is always above 10 mPas and the ratio of static viscosity η₁₀ to process viscosity η₁₀₀ is no greater than 10:1.

All amounts specified in percent by weight (wt. %) relate to the total composition of the water-based agent, if no other reference value is explicitly given. A water-based agent for the use according to the invention contains at least 5 wt. % of water.

In the present case, the liquid medium circulated in the wet scrubber is referred to as the carrier medium, the carrier medium containing the paint overspray by definition, but not being composed thereof; however, additives may be components of the carrier medium, for example a thickener as a rheological additive.

In the context of the present invention, viscosity is defined as the quotient of shear stress divided by shear rate and is experimentally determined, as what is referred to as the apparent viscosity, by means of a cone and plate rotational viscometer at a temperature of 20° C. The viscosity which is determined in this way at a shear rate of 100 s⁻¹ and approximately corresponds to the shear stress when the carrier medium runs off the separating surfaces of a facility for separating paint overspray by wet scrubbing is referred to as the process viscosity η₁₀₀. Similarly, the viscosity determined in this way at a shear rate of 10 s⁻¹ is referred to as the static viscosity η₁₀.

According to the invention, the paint overspray of a painting booth is understood to mean the paint components that are not immobilized on the surface to be painted and are transported out of the painting booth together with the booth air. Therefore, the paint overspray consists of gaseous and liquid paint components, for example solvents, flow-control agents and pigmented or unpigmented particulate binder components.

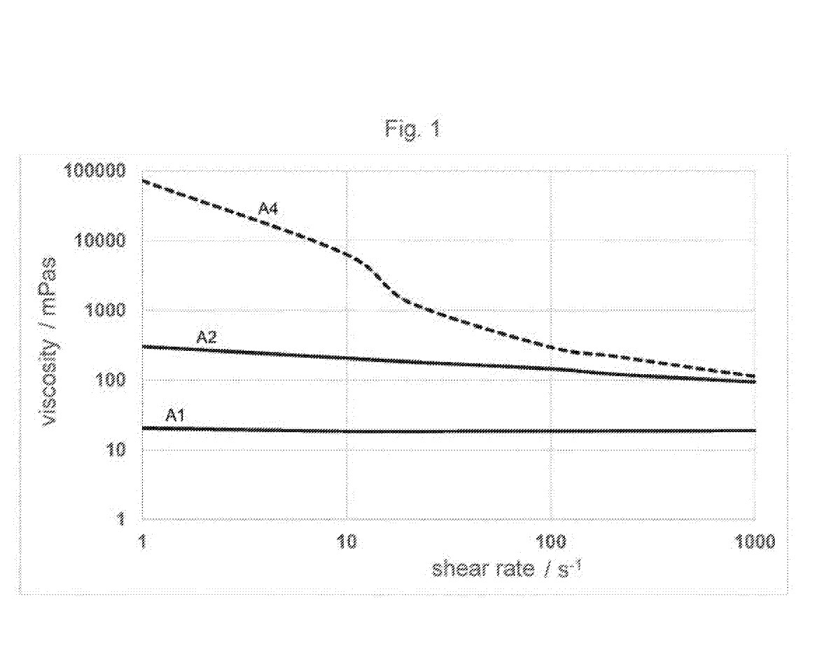

FIG. 1 shows a graph of the relation of viscosity (mPas) to shear rate (in s⁻¹) of example formulations A1 and A2, according to the invention, and comparative example formulation A4.

It has been found that the high proportion of polyfunctional organic oxo compounds according to the invention makes it possible for viscosities to be constantly set at above 10 mPas over a wide range of shear rates, without rheological additives necessarily having to be formulated together with the agent. In facilities involving electrostatically assisted separation of the paint overspray, this is advantageous in that chemical degradation of rheological additives by the ozone present in facilities of this kind does not drastically change the flow behavior. The flow property profile requires that the carrier medium flow off the separating surfaces substantially by the force of gravity in an approximately laminar manner, such that there is a homogeneous wet film thickness over the entire separating surface around which the carrier medium flows. Regions of turbulent flow which lead to sagging in the run-off behavior and thus to uncontrollable fluctuations in the wet film thickness do not exist according to the invention, and therefore it is possible to create, by means of an apparatus, as narrow a gap as possible between the separating surfaces comprising an electrode unit. At the same time, the volume flow rate, i.e. the volume of carrier medium flowing off the separating surfaces per unit of time, can be increased and therefore the paint overspray can be transported away more effectively, and the bonding of the separating surfaces owing to the increased load of paint overspray can be counteracted or a relatively higher proportion of paint overspray in the booth air can be tolerated. A person skilled in the art is able to adjust the flow property profile according to the invention by varying the amount of polyfunctional organic oxo compounds and optionally by adding a low amount of a rheological additive that is known to him. The carrier medium as defined in the use according to the invention is also advantageous in that, owing to the hygroscopic properties thereof and low vapor particle pressure, the agent containing water is well placed to absorb an amount of water from the room air that is sufficient for compensating for evaporation losses caused by the ambient temperature or air humidity changing temporarily. In this way, the run-off behavior on the separating surfaces of the wet scrubber is largely independent of the physical properties of the booth air (temperature and air humidity) and the retention time of the water-based agent according to the present invention is higher by comparison with carrier media substantially composed of water.

It is also advantageous to ensure that the carrier medium does not have excessively high levels of internal friction under process conditions, for example by adding a thickener. If the viscosity is too high, the carrier medium may run off the separating surfaces under the influence of the force of gravity so slowly that, while maintaining a volume flow rate specified in the process, a wet film is applied on the separating surfaces in a critical manner, in which the wet film of the carrier medium periodically flows downward from the separating surfaces under the effect of the force of gravity and, similarly to the case of sagging, it is not possible for the agent to flow over the entire separating surface at a homogeneous wet film thickness. Therefore, in the use according to the invention, it is preferable for the process viscosity η₁₀₀ to be no greater than 500 mPas, particularly preferably no greater than 300 mPas, more particularly preferably no greater than 200 mPas, and most particularly preferably no greater than 150 mPas.

In order for the carrier medium to flow homogeneously off the separating surfaces of the wet scrubber, it is also preferable, for the use according to the invention, for the medium to have the property whereby its flow behavior does not differ to a high degree at different levels of shear stress when flowing off said surfaces. In a particular embodiment of the use according to the invention, the ratio of static viscosity η₁₀ to process viscosity η₁₀₀ is therefore no greater than 5:1, preferably no greater than 3:1.

It has also been found that the water-based agent, in its function as a carrier medium in the wet scrubbing of paint overspray, is most suitable when at least one of the following features is additionally met for the viscosity of said agent:
a) for shear rates \dot{y} in the range of from 10 to 100 s⁻¹,

$$\vert \frac{d}{d {log}_{10} \dot{y}} η \vert$$

is always less than 100 mPas; and/or
b) for shear rates \dot{y} in the range of from 100 to 1,000 s⁻¹,

$$\vert \frac{d}{d {log}_{10} \dot{y}} η \vert$$

is always less than 50 mPas.

Each of the above-mentioned features additionally ensures that homogeneous flow behavior of the carrier medium flowing off the separating surfaces of the wet scrubber is achieved, thus overall ensuring that electrostatically assisted separation of the paint overspray is permanently carried out without any interferences, i.e. without electric arcs and short circuits. For the use according to the invention, it is therefore preferable for at least one of the above-mentioned features of the carrier medium to be met.

In the present case, a polyfunctional organic oxo compound is understood to be an organic compound that contains at least three functional groups selected from hydroxyl, ester and/or ether groups, at least one hydroxyl group always being contained, there being one heteroatom other than oxygen on at most every fifth functional group of this kind, and preferably no heteroatoms other than oxygen atoms being contained.

In a preferred embodiment of the use according to the invention, at least some of the polyfunctional organic oxo compounds are selected from low-molecular polyfunctional organic oxo compounds, low-molecular compounds of this kind having no more than 12 carbon atoms, preferably no more than 8 carbon atoms, particularly preferably no more than 6 carbon atoms. Owing to the presence of these compounds, the required viscosity behavior of the carrier medium over a wide range of shear rates and the hygroscopic properties for stabilizing a relatively low vapor particle pressure in the booth air are set.

In this connection, it is also preferable for the low-molecular polyfunctional organic oxo compounds to be selected from compounds having at least three functional groups, which are in turn selected from hydroxyl and/or ether groups, preferably from compounds having at least two hydroxyl groups, particularly preferably from compounds having at least three hydroxyl groups. Preferred representatives of the low-molecular polyfunctional organic oxo compounds are 1,2,3-propanetriol, 1,1,1-tris(hydroxymethyl)ethane, threitol, erythritol, pentaerythritol, pentitols such as xylitol, adonitol and arabitol, hexitols such as sorbitol and mannitol, aldotetroses such as erythrose, aldopentoses such as ribose and xylose, aldohexoses such as glucose and mannose and simple ethers thereof each having no more than four carbon atoms or a total of four ethylene oxide and/or propylene oxide units in the ether group, the particularly preferred representative being 1,2,3-propanetriol.

It has emerged that a proportion of low-molecular polyfunctional organic oxo compounds of at least 30 wt. %, preferably at least 60 wt. %, particularly preferably at least 80 wt. %, more particularly preferably at least 90 wt. %, and most particularly preferably at least 95 wt. %, based in each case on the total amount of the polyfunctional organic oxo compounds, empirically results in the carrier medium having the specific viscosity behavior in the use according to the invention.

As already mentioned, in the use according to the invention of the polyfunctional organic oxo compounds, the addition of rheological additives having thickening properties (“thickeners”) is often not required and, when using facilities involving electrostatically assisted separation, there is often need for subsequent controlled metering of thickeners of this kind, which are based on polymeric organic compounds. Conversely, adding organic compounds having thickening properties may be advantageous, for example in that at very low shear rates the carrier medium is given an increased viscosity, by comparison with procedurally typical shear rates, when said carrier medium is flowing off the separating surface. This is of particular technical importance in regions of the facility that have low shear rates, in order to counteract rapid sedimentation of scrubbed paint overspray in regions of the system circuit in which the overspray is difficult to access. By virtue of the method, the carrier medium is also initially circulated until a critical amount of paint overspray has been taken up, and only then is paint overspray continually removed from the carrier medium in a partial volume flow by sedimentation or flotation and the carrier medium that now does not contain the overspray is guided back to the wet scrubber circuit. Therefore, in principle, sedimentation of the paint overspray is even avoided in the circulation system.

In this connection, according to the invention, the use of a carrier medium is preferred that additionally contains polyether polyols and/or polyester polyols as polyfunctional organic oxo compounds, none of which polyols is a low-molecular compound, but each of which polyols preferably has a weight-average molar mass of less than 10,000 g/mol, particularly preferably less than 5,000 g/mol, more particularly preferably less than 2,000 g/mol. In this way, the viscosity of the carrier medium is increased, in particular in the range of low shear stresses in the range of from 1 to 100 s⁻¹, and the sedimentation of overspray in the wet scrubber circulation system is counteracted, as described above, without the viscosity of the carrier medium in the relevant shear stress range being drastically reduced after a short retention time in the system circuit owing to chemical degradation by ozone. The weight-average molar mass of the polyether polyols and/or polyester polyols is determined from molar mass distribution curves plotted using gel permeation chromatography, calibrated according to the Pullulan standards.

In the present case, a polyether polyol is understood to be an organic compound that has at least one hydroxyl group and, along its main chain, at least two ether groups that are interconnected by no more than 6 carbon atoms.

In the present case, a polyester polyol is understood to be an organic compound that has at least one hydroxyl group and, along its longest main chain, at least two ester groups that are interconnected by no more than 6 carbon atoms.

Furthermore, for applying a wet film to the separating surfaces in a manner adapted to the particular wet scrubbing facility or in order to increase the volume flow rate while at the same time maintain a laminar flow on said surfaces, the carrier medium may additionally contain a thickener which has a property whereby it increases the viscosity, in particular at shear rates in the range of from 1 to 100 s⁻¹, and is preferably selected from water-soluble or water-dispersible polymeric organic compounds having a weight-average molar mass of at least 10,000 g/mol and/or particulate phyllosilicates, particularly preferably from polymers and/or copolymers of (meth)acrylic acids and alkyl esters thereof and/or from polyurethanes. However, the present invention is characterized in that thickeners of this kind can largely be dispensed with. In a preferred embodiment, therefore, carrier media are used according to the invention that contain, in total, no more than 5 wt. %, particularly preferably no more than 2 wt. %, more particularly preferably no more than 1 wt. %, of one or more thickeners selected from water-soluble or water-dispersible polymeric organic compounds having a weight-average molar mass of at least 10,000 g/mol and/or particulate phyllosilicates.

In order to homogenize the run-off behavior of the carrier medium from the separating surfaces of the wet scrubber, said carrier medium may additionally contain at least one surface-active substance, preferably selected from non-ionic surfactants.

In a further aspect, in order to achieve the range of objects mentioned at the outset, the present invention relates to a method for separating paint overspray from the ambient air in a painting booth, characterized in that
i) the paint overspray is guided, together with the ambient air, on a separating surface wetted with a carrier medium, and
ii) part of the carrier medium that has absorbed the paint overspray from the ambient air is removed from the separating surface and is, at the same time, replaced by another part of the same carrier medium that differs from the removed part merely in that it contains less paint overspray in the same volume,
   wherein the carrier medium contains, in addition to water, more than 40 wt. % of polyfunctional organic oxo compounds, wherein, at shear rates in the range of from 10 to 1,000 s⁻¹, the carrier medium has a viscosity that is always above 10 mPas, and the ratio of static viscosity η₁₀ to process viscosity η₁₀₀ being no greater than 10:1.

In preferred embodiments of the method according to the invention, the same carrier media are used as described in detail in the context of the first aspect of the present invention. However, a method is also preferred in which the proportion of polyfunctional organic oxo compounds in the carrier medium is, in percent by weight (wt. %), no more than 400 times, preferably no more than 350 times, the difference in density in g/cm³ between the coagulate of the paint overspray and water, at 20° C. in each case. In this case, the coagulate always has a density that is above the density of water. In order to determine the density of the coagulate of the paint overspray, according to the invention, the solid fraction of the carrier medium is concentrated to between 60 and 65 wt. % by means of a decanting centrifuge, and the density of the paint sludge thus obtained is measured pycnometrically, on the basis of the solid content after said sludge has been in the drying oven for 24 hours at 120° C.

This preferred upper limit for the proportion of the polyfunctional organic oxo compounds, which limit is dependent on the density of the paint coagulate, ensures that the paint overspray in the carrier medium is not prone to flotation. Otherwise, the laminar flow of the carrier medium off the separating surfaces would be disrupted and this would also increase the risk of electric arcs between adjacent separating surfaces. However, in this connection, it is also of course true that, according to the invention, the carrier medium always has to contain more than 40 wt. % of polyfunctional organic oxo compounds, since otherwise it cannot be ensured that the carrier medium has the required flow properties.

In a preferred embodiment of the method according to the invention, the carrier medium continually flows around the separating surface, the carrier medium flowing off said surface due to the force of gravity and said carrier medium flowing around the separating surface preferably in a laminar manner.

According to the invention, laminar flow of the carrier medium on the separating surfaces is generally distinguished in that, outside of a laminar boundary layer, the carrier medium flows along the separating surface approximately in parallel therewith due to the force of gravity, and the flow is neither separated nor made turbulent in this case, such that when the volume flow rate of the flowing carrier medium is constant there is a largely steady flow along the separating surfaces.

In the method according to the invention, a wet film coating of at least 0.5 l/m², but preferably less than 2 l/m², is preferably applied to the separating surfaces, based in each case on the volume of the carrier medium.

As already mentioned in the introductory part, the method according to the invention is particularly suitable for electrostatically assisted separation of paint overspray particles. This is because, even with thicker wet film coatings of at least 0.5 l/m², the homogeneous, and thus easily adjustable, flow behavior of the carrier medium makes it possible to arrange separating surfaces in parallel with one another at a very small spacing, without this producing a risk of electric arcs resulting from an unsteady, inhomogeneous flow of the carrier medium that could compromise continual and economical operation. In this respect, in the method according to the invention, for as efficient a paint overspray separation as possible, it is preferable for said paint spray to be electrostatically charged in the ambient air under the action of a voltage and to be transported toward the separating surface in the electric field. For this, it is also preferable for the separating surface to be made of a planar metal material and for the voltage to be preferably applied between the separating surface and a metal electrode that is in direct contact with the ambient air.

### EXAMPLES

Example formulations are given below that can be used as water-based carrier media for wet scrubbing of paint overspray. The formulations A1-A3 according to the invention have the required property profile in respect of viscosity and thus, in the case of electrostatically assisted separation, provide for an economical mode of operation in the wet scrubber, combined with a high volume rate of the carrier medium flowing around the separating surfaces (see FIG. 1).

TABLE 1

Proportions by weight in %

| | A1 | A2 | A3 | A4 |
|---|---|---|---|---|
| Glycerol | 67.5 | 67.5 | 67.5 | 35 |
| Thickener | — | 0.7¹ | 0.7¹ | 1.0² |
| Surfactant | — | — | 1.0³ | — |
| Water | 32.5 | 31.8 | 30.8 | 64 |

¹based on polyacrylate
²based on polyurethane
³based on 4-times ethoxylated C12-C14 fatty alcohol

What is claimed is:

1. A method of wet scrubbing paint overspray from circulating air comprising steps of:
i) providing a water-based agent comprising more than 40 wt. % of polyfunctional organic oxo compounds as a carrier medium for carrying paint overspray;
ii) contacting a separating surface with the carrier medium by flowing the carrier medium over the separating surface, the carrier medium flowing off of the separating surface in an approximately laminar manner, such that there is a homogeneous wet film thickness over the entire separating surface around which the carrier medium flows,
iii) transporting paint overspray together with circulating air along the separating surfaces contacting the carrier medium with paint overspray thereby transferring paint overspray into the carrier medium;
the water-based agent being selected such that at a range of shear rates of from 10 to 1,000 s-1, the water-based agent has a viscosity that is always greater than 10 mPas and the ratio of static viscosity η10 to process viscosity η100 is no greater than 10:1.

2. The method according to claim 1, wherein at least some of the polyfunctional organic oxo compounds are selected from low-molecular polyfunctional organic oxo compounds, having no more than 12 carbon atoms.

3. The method according to claim 1, wherein the low-molecular polyfunctional organic oxo compounds comprise at least three functional groups selected from hydroxyl groups, ether groups and combinations thereof.

4. The method according to claim 3, wherein the low-molecular polyfunctional organic oxo compounds comprise at least three hydroxyl groups and are present in an amount of at least 60 wt. %, based on the total amount of the polyfunctional organic oxo compounds.

5. The method according to claim 2, wherein the low-molecular polyfunctional organic oxo compounds are present in an amount of at least 30 wt. %, based on the total amount of the polyfunctional organic oxo compounds.

6. The method according to claim 1, wherein polyether polyols and/or polyester polyols are additionally contained as polyfunctional organic oxo compounds, none of said polyols being low-molecular polyfunctional organic oxo compound; and wherein each of said polyols has a weight-average molar mass of less than 10,000 g/mol.

7. The method according to claim 1, wherein the polyfunctional organic oxo compounds are present in an amount of greater than 50 wt. %, but no more than 80 wt. %.

8. The method according to claim 1, wherein a wet film coating of at least 0.5 l/m², but less than 2 l/m², is applied to the separating surfaces, based in each case on the carrier medium volume.

9. The method according to claim 9, wherein the paint overspray is electrostatically charged in the ambient air under the action of a voltage in an electric field and is transported toward the separating surface in the electric field.

10. The method according to claim 9, wherein the proportion of polyfunctional organic oxo compounds is, in percent by weight based on the carrier medium, no more than 400 times, the difference in density in g/cm³ between the coagulate of the paint overspray and water.

11. The method according to claim 1, wherein for:
shear rates \dot{y} in the range of from 100 to 1,000 s⁻¹,
$$\vert \frac{d}{d {log}_{10} \dot{y}} η \vert$$
is always less than 50 mPas.

12. A method for separating paint overspray from the ambient air, comprising steps of:
i) guiding paint overspray, together with ambient air, on a separating surface wetted with a carrier medium comprising water and more than 40 wt. % of polyfunctional organic oxo compounds, such that the paint overspray is absorbed by the carrier medium; and
ii) a part of the carrier medium that has absorbed the paint overspray from the ambient air is removed from the separating surface and is, at the same time, replaced by another part of the same carrier medium that differs from the removed part merely in that it contains less paint overspray in the same volume;
wherein the carrier medium has a viscosity greater than 10 mPas, at shear rates in a range of from 10 to 1,000 s⁻¹, and has a ratio of static viscosity η₁₀ to process viscosity η₁₀₀ that is no greater than 10:1.

13. The method according to claim 12, wherein the carrier medium continually flows around the separating surface and the carrier medium flows off said surface due to the force of gravity, said carrier medium flowing around the separating surface in a laminar manner.

14. The method according to claim 12, wherein a wet film coating of at least 0.5 l/m², but less than 2 l/m², is applied to the separating surfaces, based in each case on the carrier medium volume.

15. The method according to claim 12, wherein the paint overspray is electrostatically charged in the ambient air under the action of a voltage in an electric field and is transported toward the separating surface in the electric field.

16. The method according to claim 12, wherein the proportion of polyfunctional organic oxo compounds is, in percent by weight based on the carrier medium, no more than 400 times, the difference in density in g/cm³ between the coagulate of the paint overspray and water.
